(19) United States
(12) Patent Application Publication
(10) Pub. No.: US 2019/0284475 A1
(43) Pub. Date: Sep. 19, 2019

(54) LIQUID CRYSTAL COMPOUND AND A LIQUID CRYSTAL COMPOSITION INCLUDING THE SAME

(71) Applicant: DAXIN MATERIALS CORP., Taichung City (TW)

(72) Inventors: Chung-Hsien Wu, Taichung City (TW); Yi-Chun Lin, Taichung City (TW); Chun-Chih Wang, Taichung City (TW)

(73) Assignee: DAXIN MATERIALS CORP., Taichung City (TW)

(21) Appl. No.: 16/298,073

(22) Filed: Mar. 11, 2019

(30) Foreign Application Priority Data
Mar. 14, 2018 (TW) 107108697

(51) Int. Cl. C09K 19/34; C09K 19/12; C09K 19/20; C09K 19/30

(52) U.S. Cl. CPC C09K 19/3405; C09K 19/12; C09K 19/20; C09K 2019/3408; C09K 2019/123; C09K 2019/3016; C09K 19/3003

(57) ABSTRACT

The disclosure is a liquid crystal compound represented by Formula (I),

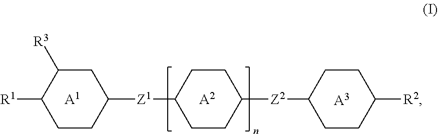

wherein R¹, R², R³, ring A¹, ring A², ring A³, Z¹, Z², and n have definitions that are described in details herein. The liquid crystal compound represented by Formula (I) can be used to prepare a liquid crystal composition that has superior low-temperature storage.

### CROSS-REFERENCE TO RELATED APPLICATION

This application claims priority of Taiwanese Patent Application No. 107108697, filed on Mar. 14, 2018.

### FIELD

The disclosure relates to a liquid crystal compound, and more particularly to a liquid crystal compound containing a terminal 1,4-phenylene group having a non-polar substituent at position 2 thereof. The disclosure also relates to a liquid crystal composition including the liquid crystal compound.

### BACKGROUND

With the widespread use of liquid crystal display devices, the liquid crystal compounds used in the liquid crystal display devices are required to have various properties such as a low driving voltage, a fast response time, a high voltage holding ratio, a low rotational viscosity, and a wide operation temperature range. Therefore, there is a continuous demand in the art to provide a novel liquid crystal compound or composition that can meet the requirements for various applications.

U.S. Pat. No. 4,808,333 discloses a liquid crystal mixture containing at least two anisotropic compounds, at least one of which is represented by Formula (A):

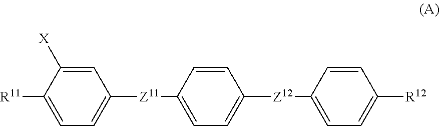

wherein

Z¹¹ and Z¹² each, independently of one another, represent a single bond or —CH₂CH₂—;

X represents F, Cl, or methyl; and

R¹¹ and R¹² each, independently of one another, represent C₁-C₁₂ alkyl, C₁-C₁₂ alkoxy, C₁-C₁₂ alkanoyloxy, or C₁-C₁₂ alkylamino.

The compound represented by Formula (A) is a nematic liquid crystal, and has properties such as a high dielectric anisotropy and the like.

In addition to the dielectric property, liquid crystal compounds are also required to be driven by a low voltage over a wide temperature range and to be stably stored, and the original properties thereof are also required to be maintained at a low-temperature environment (for example, not higher than −20° C. or −30° C.). For example, CN 106190173A discloses a liquid crystal compound represented by Formula (B):

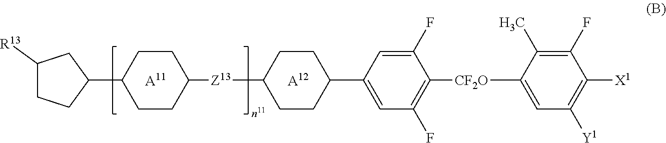

wherein

R¹³ is H or C₁-C₁₅ alkyl;

X¹ is F, Cl, CN, NCS, or fluoroalkyl;

Y¹ is H or F;

rings A¹¹ and A¹² each, independently of one another, represent

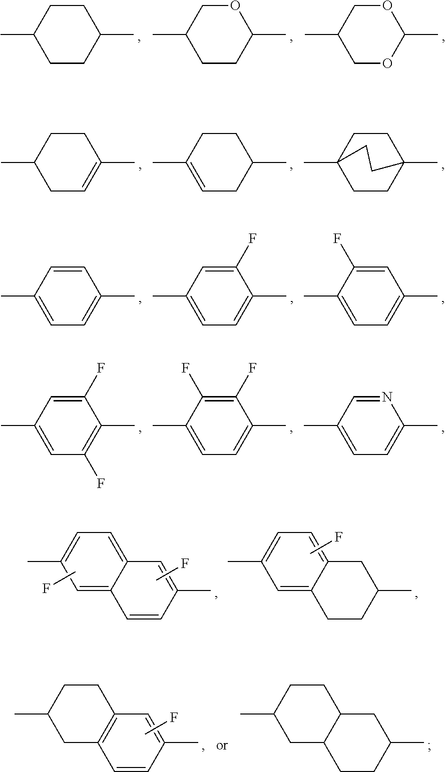

Z¹³ represent a single bond, —CH₂CH₂—, —CH═CH—, —CH₂O—, —OCH₂—, —C═C—, —CH₂CF₂—, —CHFCHF—, —CF₂CH₂—, —CH₂CHF—, —CHFCF₂—, —C₂F₄—, —COO—, —OCO—, —CF₂O—, or —OCF₂—; and

n¹¹ is 0 or 1.

CN 106256873A discloses a compound represented by Formula (C):

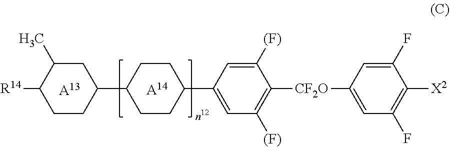

wherein

X² represents F, Cl, OCF₃, CN, NCS, or C₁-C₅ alkyl having 1 to 3 fluoro substituents;

R¹⁴ is H or C₁-C₁₅ alkyl;

n¹² is 0, 1, or 2; and

rings A¹³ and A¹⁴ each, independently of one another, represent

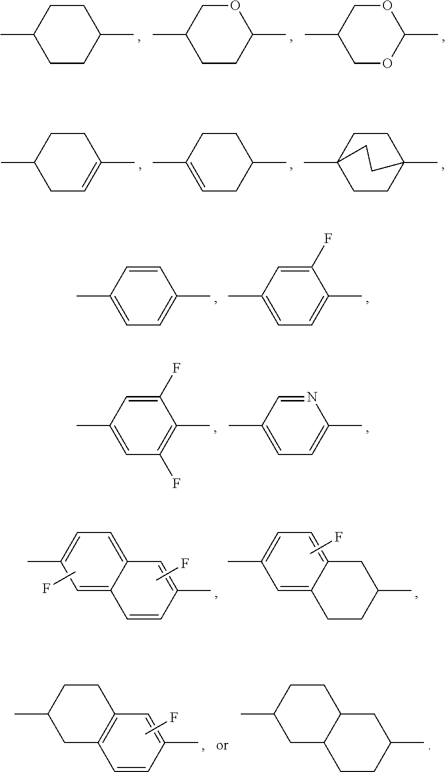

In addition the liquid crystal compounds disclosed in the aforesaid documents, there is a continuous demand in the art to provide a novel liquid crystal compound having low-temperature stability.

### SUMMARY

Therefore, a first object of the disclosure is to provide a liquid crystal compound having low-temperature stability.

A second object of the disclosure is to provide a liquid crystal composition which includes the liquid crystal compound.

According to a first aspect of the disclosure, there is provided a liquid crystal compound represented by Formula (I):

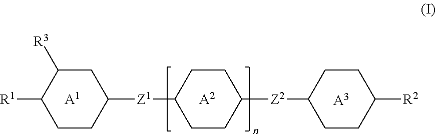

wherein

R¹ and R² each, independently of one another, represent F, Cl, H, a C₁-C₁₅ straight alkyl group, a C₃-C₁₅ branched alkyl group, a C₁-C₁₅ straight alkoxy group, or a C₃-C₁₅ branched alkoxy group, wherein at least one —CH₂— group in each of the C₁-C₁₅ straight alkyl group, the C₃-C₁₅ branched alkyl group, the C₁-C₁₅ straight alkoxy group, and the C₃-C₁₅ branched alkoxy group is optionally replaced with —C═C—, —CH═CH—, —CF₂O—, —O—, —COO—, —OCO—, or —OOC—, and each of the C₁-C₁₅ straight alkyl group, the C₃-C₁₅ branched alkyl group, the C₁-C₁₅ straight alkoxy group, and the C₃-C₁₅ branched alkoxy group is unsubstituted or substituted with at least one halogen atom;

R³ represents a C₁-C₅ straight alkyl group or a C₃-C₈ branched alkyl group;

ring A¹ represents 1,4-phenylene or 1,4-cyclohexylene;

ring A² and ring A³ each, independently of one another, represent 1,4-phenylene, 1,4-cyclohexylene, 2-fluoro-1,4-phenylene, 3-fluoro-1,4-phenylene, 2,6-difluoro-1,4-phenylene, 3,5-difluoro-1,4-phenylene, 2,3-difluoro-1,4-phenylene, 1,3-cyclopentylene, 1,3-cyclobutylene, pyridine-2,5-diyl, pyrimidine-2,5-diyl, benzofuran-2,5-diyl, 1,3-dioxane-2,5-diyl, or tetrahydropyran-2,5-diyl;

Z¹ and Z² each, independently of one another, represent a single bond, —CH₂—CH₂—, —C═C—, —CH═CH—, —CF₂O—, —OCF₂—, —CH₂O—, —OCH₂—, —COO—, —OCO—, —OOC—, —CF₂—CF₂—, or —CF═CF—; and

n is an integer from 0 to 4,

with the proviso that

at least one of said ring A² and said ring A³ is 2-fluoro-1,4-phenylene, 3-fluoro-1,4-phenylene, 2,6-difluoro-1,4-phenylene, 3,5-difluoro-1,4-phenylene, or 2,3-difluoro-1,4-phenylene;

when n is 0, said ring A³ is not 2,3-difluoro-1,4-phenylene;

when n is an integer from 2 to 4, said rings A² are the same or different; and

when Z² represents —CF₂O— and said ring A³ represents 2,6-difluoro-1,4-phenylene, n is 2 and

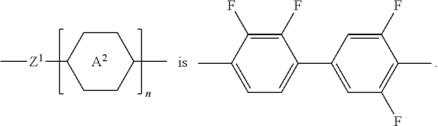

According to a second aspect of the disclosure, there is provided a liquid crystal composition, which includes the liquid crystal compound represented by Formula (I).

The liquid crystal compound of the disclosure has a specific molecular structure represented by Formula (I), and thus a liquid crystal composition including the liquid crystal compound of the disclosure has superior low-temperature stability.

### DETAILED DESCRIPTION

A liquid crystal compound according to the disclosure is represented by Formula (I):

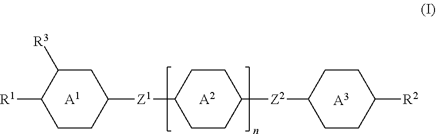

wherein

R¹ and R² each, independently of one another, represent F, Cl, H, a C₁-C₁₅ straight alkyl group, a C₃-C₁₅ branched alkyl group, a C₁-C₁₅ straight alkoxy group, or a C₃-C₁₅ branched alkoxy group, wherein at least one —CH₂— group in each of the C₁-C₁₅ straight alkyl group, the C₃-C₁₅ branched alkyl group, the C₁-C₁₅ straight alkoxy group, and the C₃-C₁₅ branched alkoxy group is optionally replaced with —C═C—, —CH═CH—, —CF₂O—, —O—, —COO—, —OCO—, or —OOC—, and each of the C₁-C₁₅ straight alkyl group, the C₃-C₁₅ branched alkyl group, the C₁-C₁₅ straight alkoxy group, and the C₃-C₁₅ branched alkoxy group is unsubstituted or substituted with at least one halogen atom;

R³ represents a C₁-C₈ straight alkyl group or a C₃-C₈ branched alkyl group;

ring A¹ represents 1,4-phenylene or 1,4-cyclohexylene;

ring A² and ring A each, independently of one another, represent 1,4-phenylene, 1,4-cyclohexylene, 2-fluoro-1,4-phenylene, 3-fluoro-1,4-phenylene, 2,6-difluoro-1,4-phenylene, 3,5-difluoro-1,4-phenylene, 2,3-difluoro-1,4-phenylene, 1,3-cyclopentylene, 1,3-cyclobutylene, pyridine-2,5-diyl, pyrimidine-2,5-diyl, benzofuran-2,5-diyl, 1,3-dioxane-2,5-diyl, or tetrahydropyran-2,5-diyl;

Z¹ and Z² are each, independently of one another, represent a single bond, —CH₂—CH₂—, —C═C—, —CH═CH—, —CF₂O—, —OCF₂—, —CH₂O—, —OCH₂—, —COO—, —OCO—, —OOC—, —CF₂—CF₂—, or —CF═CF—; and

n is an integer from 0 to 4,

with the proviso that

at least one of said ring A² and said ring A³ is 2-fluoro-1,4-phenylene, 3-fluoro-1,4-phenylene, 2,6-difluoro-1,4-phenylene, 3,5-difluoro-1,4-phenylene, or 2,3-difluoro-1,4-phenylene;

when n is 0, said ring A³ is not 2,3-difluoro-1,4-phenylene;

when n is an integer from 2 to 4, said rings A² are the same or different; and

when Z² represents —CF₂O— and said ring A³ represents 2,6-difluoro-1,4-phenylene, n is 2 and

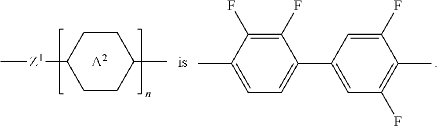

The term “pyridine-2,5-diyl” as used herein includes

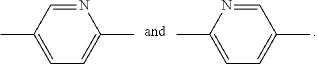

The term “pyrimidine-2,5-diyl” as used herein includes

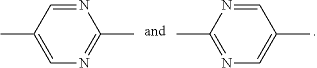

The term “benzofuran-2,5-diyl” as used herein includes and

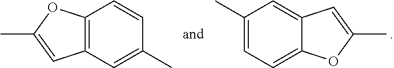

The term “1,3-dioxane-2,5-diyl” as used herein includes

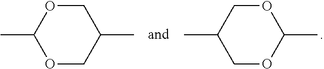

The term “tetrahydropyran-2,5-diyl” as used herein includes

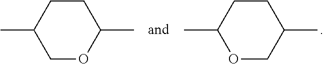

In certain embodiments, R³ is methyl.

In certain embodiments, Z¹ is a single bond.

In certain embodiments, Z² represents a single bond, —CH₂O—, or —CF₂O—.

In certain embodiments, the liquid crystal compound represented by Formula (I) is selected from the group consisting of liquid crystal compounds represented by Formulae (I-1), (I-2), (I-3), (I-4), (I-5), (I-6), (I-7), and (I-8),

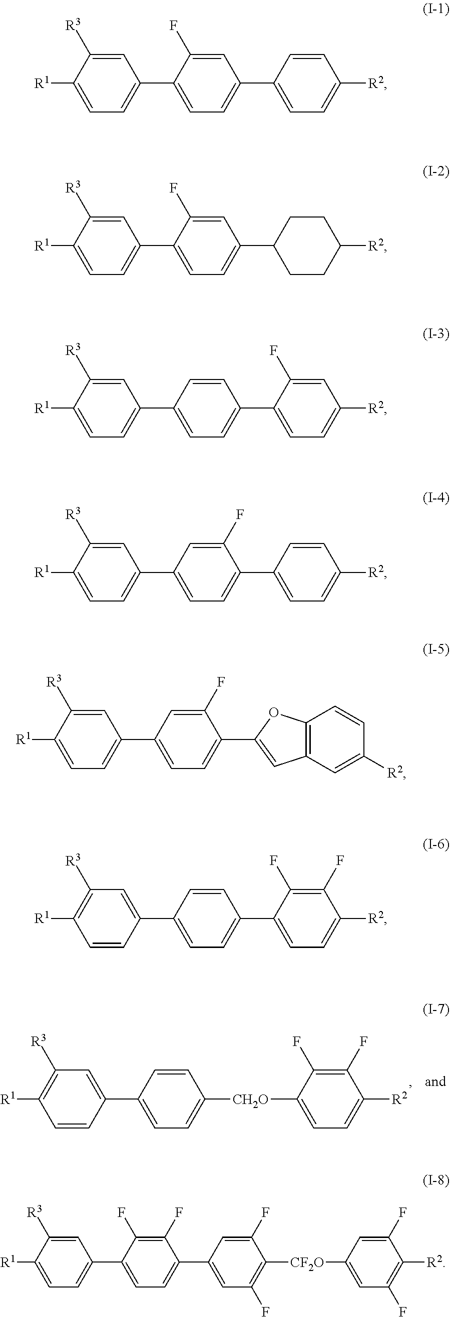

In certain embodiments, R³ in each of Formulae (I-1) to (1-8) is methyl

In certain embodiments, in each of Formulae (I-1) to (1-8), R¹ represents a C₁-C₅ straight alkyl group or a C₃-C₅ branched alkyl group, and R² represents F, a C₁-C₅ straight alkyl group, a C₃-C₅ branched alkyl group, a C₁-C₅ straight alkoxy group, or a C₃-C₅ branched alkoxy group.

In certain embodiments, the liquid crystal compound represented by Formula (I-1) is selected from the group consisting of liquid crystal compounds represented by Formulae (I-1a), (I-1b), and (I-1c):

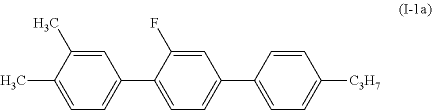

(referred to as 1MG′P3 hereinafter),

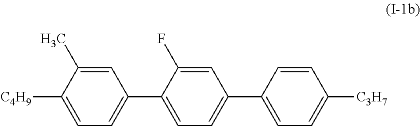

(referred to as 4MG′P3 hereinafter),

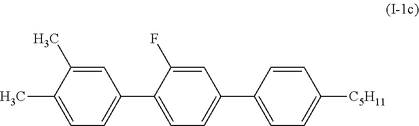

(referred to as 1MG′P5 hereinafter).

In certain embodiments, the liquid crystal compound represented by Formula (I-2) is a liquid crystal compound represented by Formula (I-2a):

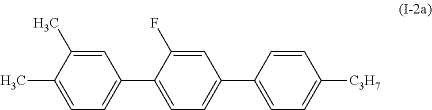

(referred to as 1MG′C3 hereinafter).

In certain embodiments, the liquid crystal compound represented by Formula (I-3) is a liquid crystal compound represented by Formula (I-3a):

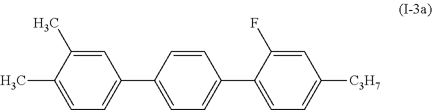

(referred to as 1MPG′3).

In certain embodiments, the liquid crystal compound represented by Formula (I-4) is a liquid crystal compound represented by Formula (I-4a):

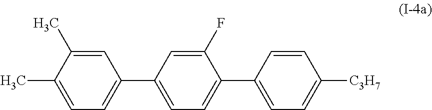

(referred to as 1MGP3 hereinatter).

In certain embodiments, the liquid crystal compound represented by Formula (I-5) is a liquid crystal compound represented by Formula (I-5a):

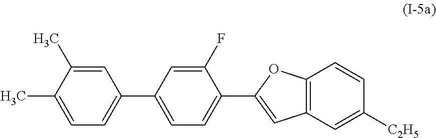 [SMILES: CCc1ccc2oc(-c3ccc(-c4ccc(C)c(C)c4)cc3F)cc2c1]

(referred to as 1MGB2 hereinafter).

In certain embodiments, the liquid crystal compound represented by Formula (I-6) is a liquid crystal compound represented by Formula (I-6a):

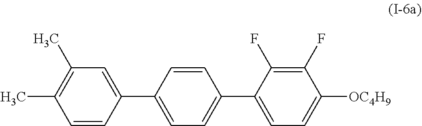

(referred to as 1MPYO4 hereinafter).

In certain embodiments, the liquid crystal compound represented by Formula (I-7) is a liquid crystal compound represented by Formula (I-7a):

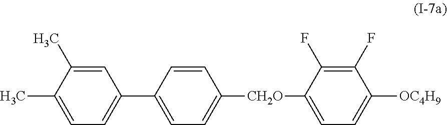

(referred to as IMP1OYO4 hereinafter).

In certain embodiments, the liquid crystal compound represented by Formula (I-8) is selected from the group consisting of liquid crystal compounds represented by Formulae (I-8a) and (I-8b):

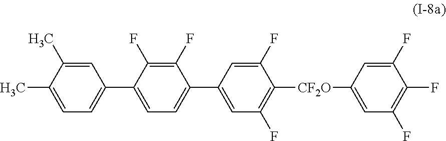

(referred to as 1MYUQUF hereinafter),

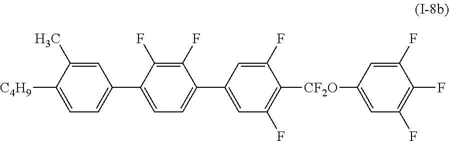

(referred to as 4MYUQUF hereinafter).

The liquid crystal compound represented by Formula (I) can be prepared by any well-known synthesis method, for example, by reaction schemes (A) or (B) below.

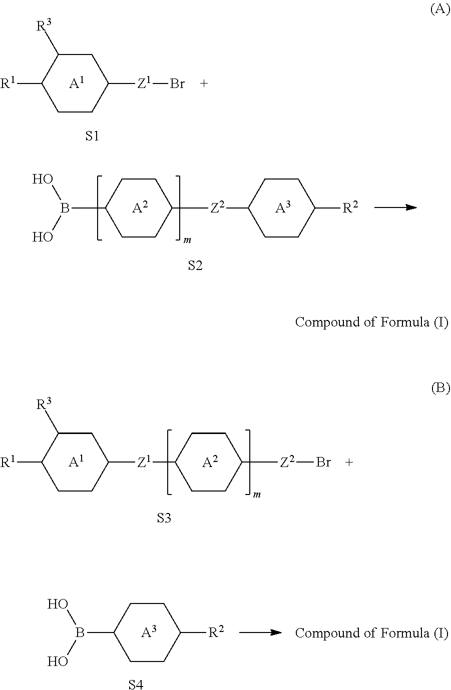

(The groups in reaction schemes (A) and (B) are the same as those defined for Formula (I))

A liquid crystal composition according to the disclosure includes at least one liquid crystal compound represented by Formula (I) as defined above.

In certain embodiments, the liquid crystal composition according to the disclosure includes at least one liquid crystal compound selected from the group consisting of compounds represented by Formulae (I-1), (I-2), (I-3), (I-4), (I-5), (I-6), (I-7), and (I-8) as defined above.

In certain embodiments, the liquid crystal composition according to the disclosure further includes a liquid crystal compound represented by Formula (II),

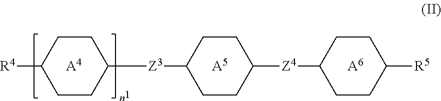

wherein

R⁴ and R⁵ each, independently of one another, represent H, a halogen atom, a C₁-C₁₅ straight alkyl group, a C₃-C₁₅ branched alkyl group, a C₂-C₁₅ straight alkenyl group, or a C₄-C₁₅ branched alkenyl group, wherein each of the C₁-C₁₅ straight alkyl group, the C₃-C₁₅ branched alkyl group, the C₂-C₁₅ straight alkenyl group, and the C₄-C₁₅ branched alkenyl group is independently unsubstituted or substituted with at least one halogen atom, and at least one —CH₂— group in each of the C₁-C₁₅ straight alkyl group, the C₃-C₁₅ branched alkyl group, the C₂-C₁₅ straight alkenyl group, and the C₄-C₁₅ branched alkenyl group is optionally replaced with a —O— radical, with the proviso that when at least two of the —CH₂— groups are replaced with the —O— radicals, the —O— radicals are not bonded to each other directly;

ring A⁴, ring A⁵, and ring A⁶ each, independently of one another, represent 1,4-phenylene, 1,4-cyclohexylene, benzofuran-2,5-diyl, 1,3-dioxane-2,5-diyl, tetrahydropyran-2,5-diyl, a divalent dioxa-bicyclo[2.2.2]octyl functional group, a divalent trioxa-bicyclo[2.2.2]octyl functional group, or indane-2,5-diyl, wherein each of the 1,4-phenylene, the benzofuran-2,5-diyl, the 1,3-dioxane-2,5-diyl, the tetrahydropyran-2,5-diyl, the divalent dioxa-bicyclo[2.2.2]octyl functional group, and the divalent trioxa-bicyclo[2.2.2]octyl functional group is unsubstituted or substituted with at least one fluorine, the indane-2,5-diyl is unsubstituted or substituted with at least one radical selected from the group consisting of a halogen atom and CN, and at least one —CH₂— group in each of the 1,4-cyclohexylene, the 1,3-dioxane-2,5-diyl, the tetrahydropyran-2,5-diyl, the divalent dioxa-bicyclo[2.2.2]octyl functional group, the divalent trioxa-bicyclo[2.2.2]octyl functional group, and the indane-2,5-diyl is replaced with a first radical selected from the group consisting of —O—, —N—, and —S—, with the proviso that at least two of the —CH₂— groups are replaced with the first radicals, the first radicals are not bonded to each other directly;

Z³ and Z⁴ each, independently of one another, represent a single bond, a C₁-C₄ alkylene group, a C₂-C₄ alkenylene group, or a C₂-C₄ alkynylene group, wherein each of the C₁-C₄ alkylene group, the C₂-C₄ alkenylene group, and the C₂-C₄ alkynylene group is unsubstituted or substituted with at least one CN, and at least one —CH₂— group in each of the C₁-C₄ alkylene group, the C₂-C₄ alkenylene group, and the C₂-C₄ alkynylene group is replaced with a radical selected from the group consisting of —O— and —S—, with the proviso that —O— and —S— are not bonded to each other directly, —O— is not bonded to —O— directly, and —S— is not bonded to —S— directly; and

n¹ is an integer from 0 to 2.

The term “divalent dioxa-bicyclo[2.2.2]octyl functional group” as used herein includes

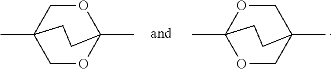

The term “divalent trioxa-bicyclo[2.2.2]octyl functional group” as used herein includes

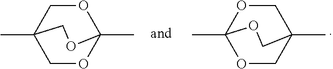

The term “indane-2,5-diyl” as used herein includes

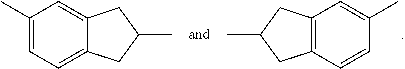

In certain embodiments, examples of the liquid crystal compound represented by Formula (II) include, but are not limited to, 3CCV, 3CCV1, 3PTPO1, V2PTP2V, 3PGB2, 2PGB2, 3CPTP2, 3CCP1, VCCP1, 3CPP2, 3CPPC3, 3CPTPO2, 2CPYO2, 3CCYO1, 3PYO2, 2PYO2, 3CYO4, 3CCYO2, 2CC1OYO2, 3CC5, 3CPPF, 3CPGF, 5CCGF, 3CCGF, 5CCPOCF3, 4CCPOCF3, 3CCPOCF3, 3CCPGF, 3CCPF, 3doPUOVF2, 3doPUF, 1RIGUOVF2, and 2doPUOVF2. The groups contained in the examples of the liquid crystal compound of Formula (II) are represented using the codes described above, of which the meanings are shown in Table 1 below.

The examples of the liquid crystal compound represented by Formula (II) include liquid crystal compounds used as viscosity-reducing agents (for example, 3CCV, 3CCV1, 3CC5, and the like), liquid crystal compounds that provide a high Δn value (for example, 3PTPO1, 3PGB2, and the like), negative liquid crystal compounds (for examples, 3PYO2, 2CPYO2, 3CYO4, and the like), and liquid crystal compounds that provide a high Δε value (for example, 3doPUOVF2, 3doPUF, 1RIGUOVF2, 2doPUOVF2, and the like). Therefore, the viscosity, the Δn value, and/or the Δε value of the liquid crystal composition of the disclosure can be adjusted by varying the content of the liquid crystal compound of Formula (II) contained in the liquid crystal composition.

In certain embodiments, the liquid crystal composition according to the disclosure further includes a liquid crystal compound represented by Formula (III),

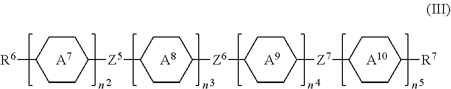

wherein

R⁷ represents F, Cl, —CH₃, —CF₃, —OCH═CF₂, or —OCF₃;

R⁶ represents H, a C₁-C₁₀ straight alkyl group, a C₃-C₁₀ branched alkyl group, a C₂-C₁₀ straight alkenyl group, or a C₄-C₁₀ branched alkenyl group, wherein each of the C₁-C₁₀ straight alkyl group, the C₃-C₁₀ branched alkyl group, the C₂-C₁₀ straight alkenyl group, and the C₄-C₁₀ branched alkenyl group is unsubstituted or substituted with at least one radical selected from the group consisting of a halogen atom, CN, and CF₃, and at least one —CH₂— group in each of the C₁-C₁₀ straight alkyl group, the C₃-C₁₀ branched alkyl group, the C₂-C₁₀ straight alkenyl group, and the C₄-C₁₀ branched alkenyl group is replaced with a second radical selected from the group consisting of —O—, —S—, —CO—, —O—CO—, —CO—O—, and —O—CO—O—, with the proviso that when at least two of the —CH₂— groups are replaced with the second radicals, the second radicals are not bonded to each other directly;

ring A⁷, ring A⁸, ring A⁹, and ring A¹⁰ each, independently of one another, represent 1,4-phenylene, 1,4-cyclohexylene, tetrahydropyran-2,5-diyl, a divalent dioxa-bicyclo[2.2.2]octyl functional group, a divalent trioxa-bicyclo[2.2.2]octyl functional group, or indane-2,5-diyl, wherein each of the 1,4-phenylene, the 1,4-cyclohexylene, and the indane-2,5-diyl is unsubstituted or substituted with at least one radical selected from the group consisting of a halogen atom and CN, and at least one —CH₂— group in each of the 1,4-phenylene, the 1,4-cyclohexylene, and the indane-2,5-diyl is replaced with a third radical selected from the group consisting of —O—, —N—, and —S—, with the proviso that when at least two of the —CH₂— groups are replaced with the third radicals, the third radicals are not bonded to each other directly;

Z⁵, Z⁶, and Z⁷ each, independently of one another, represent a single bond, a C₁-C₄ alkylene group, a C₂-C₄ alkenylene group, a C₂-C₄ alkynylene group, —CO—O—, or —O—CO—, wherein each of the C₁-C₄ alkylene group, the C₂-C₄ alkenylene group, and the C₂-C₄ alkynylene group is unsubstituted or substituted with at least one halogen atom, and at least one —CH₂— group in each of the C₁-C₄ alkylene group, the C₂-C₄ alkenylene group, and the C₂-C₄ alkynylene group is replaced with a radical selected from the group consisting of —O— and —S—, with the proviso that —O— and —S— are not bonded to each other directly, —O— is not bonded to —O— directly, and —S— is not bonded to —S— directly, and that at least one of Z⁵, Z⁶, and Z⁷ is —CF₂—O— or —O—CF₂—; and

n², n³, n⁴, and n³ each, independently of another, represent an integer from 0 to 3, with the proviso that a total of n², n³, n⁴, and n⁵ is at least 3.

Examples of the liquid crystal compound represented by Formula (III) include, but are not limited to, 3PGUQUF, 4PGUQUF, 5PGUQUF, 2RIGUQUF, 3RIGUQUF, 3doPUQUF, 2toUQUOVF2, 3RIGUQUF, and RIGUQUF. The groups contained in the examples of the liquid crystal compound of Formula (III) are represented using the codes described above, of which the meanings are shown in Table 1 below.

When the liquid crystal composition includes the liquid crystal compound represented by Formula (III) wherein one of Z⁵, Z⁶, and Z⁷ is —CF₂O— or —OCF₂—, the rotational viscosity thereof can be reduced and the dielectric anisotropy (As) thereof can be enhanced.

Since the rotational viscosity is proportional to the response time of liquid crystal molecules, when a voltage is applied, the response speed of the liquid crystal molecules can be increased effectively by reducing the rotational viscosity. Therefore, when the liquid crystal compound of Formula (III) containing —CF₂O— or —OCF₂— is used in the liquid crystal composition, the dielectric anisotropy and the rotational viscosity of the liquid crystal composition can be improved desirably.

When the liquid crystal composition includes the liquid crystal compound represented by Formula (III) wherein one of A⁷, A⁸, A⁹, and A¹⁰ is the groups of RI, to, and/or do shown in Table 1 below, the dielectric anisotropy (Δε) thereof can be enhanced. Therefore, the dielectric anisotropy and/or the rotational viscosity of the liquid crystal composition can be adjusted desirably by selecting the liquid crystal compound of Formula (III), which contains specific A⁷, A⁸, A⁹, and/or A¹⁰, to be used in the liquid crystal composition.

Since the liquid crystal composition of the disclosure includes the liquid crystal compound represented by Formula (I), the low-temperature stability thereof can be enhanced effectively. In addition to the liquid crystal compounds of Formulae (I), (II), and (III), the liquid crystal composition of the disclosure can further include the additives commonly used in the art. Examples of the additives include, but are not limited to, chiral doping agents, ultraviolet stabilizers, antioxidants, free radical scavenging agents, and nanoparticles.

The amounts of the liquid crystal compounds of Formulae (I), (II), and/or (III) used in the liquid crystal composition of the disclosure can be adjusted according to specific requirements. In certain embodiments, the amount of the liquid crystal compound of Formula (I) is in a range from 0.1 wt % to 50 wt % based on 100 wt % of the liquid crystal composition. In certain embodiments, the amount of the liquid crystal compound of Formula (II) is in a range from 10 wt % to 90 wt % based on 100 wt % of the liquid crystal composition. In certain embodiments, the amount of the liquid crystal compound of Formula (III) is in a range from 1 wt % to 50 wt % based on 100 wt % of the liquid crystal composition.

Examples of the disclosure will be described hereinafter. It is to be understood that these examples are exemplary and explanatory and should not be construed as a limitation to the disclosure.

### Example 1: Preparation of a Liquid Crystal Compound of Formula (I-1a)

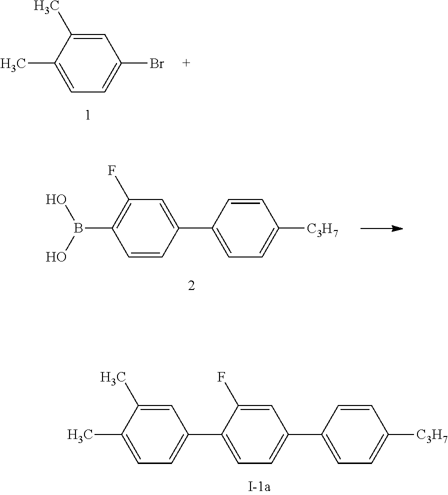

Compound 1 (1 g, 5.4 mmol), tetrahydrofuran (50 ml), water (10 ml), and potassium carbonate (3.4 g, 24.6 mmol) were added into a reaction vial (250 ml) and were mixed under stirring, followed by purging with nitrogen gas for 30 minutes to remove oxygen from the reaction vial. Compound 2 (2.1 g, 8.1 mmol) and tetrakis(triphenylphosphine) palladium (0) (0.31 g, 0.268 mmol) were added into the reaction vial to form a mixture. The mixture was heated under reflux for 5 hours, followed by extracting with ethyl acetate and water and collecting an organic layer. The solvent contained in the organic layer was removed using a rotary evaporator to obtain a crude product. The crude product was purified via column chromatography to obtain a compound of Formula (I-1a) as a white solid.

The compound of Formula (I-1a) was identified using a nuclear magnetic resonance (NMR) spectrometer. The result is shown below.

¹H-NMR (CDCl₃, 400 MHz), δ (ppm): 0.99 (t, J=7.6 Hz, 3H), 1.65-1.74 (m, 2H), 2.34 (d, J=6.8 Hz, 6H), 2.65 (t, J=7.6 Hz, 2H), 7.22-7.55 (m, 10H).

### Example 2: Preparation of a Liquid Crystal Compound of Formula (I-b)

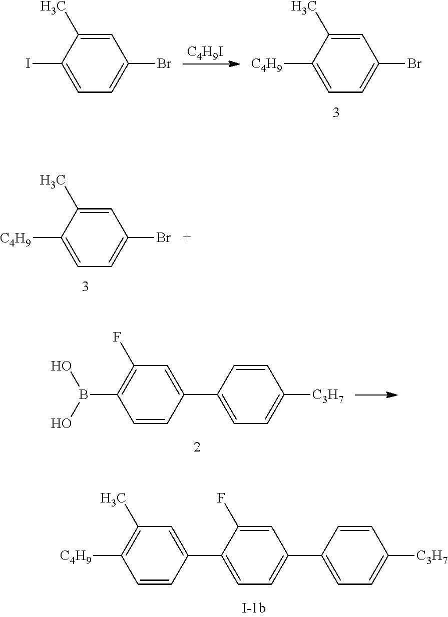

2-methyl-4-bromo-iodobenzene (6.0 g, 20.2 mmol) and anhydrous tetrahydrofuran (40 ml) were added into a reaction vial (100 ml) and were mixed under stirring until complete dissolution. The temperature in the reaction vial was reduced to −78° C., and n-butyl lithium (2.5M, 10 ml, 26.3 mmol) was slowly added into the reaction vial, followed by a reaction for 1 hour. 1-iodobutane (5.6 g, 30.3 mmol) was added into the reaction vial at −78° C. to form a mixture, followed by subjecting the mixture in the reaction vial to a reaction at a temperature from 20° C. to 30° C. for 2 hours. A dilute hydrochloric acid solution (1N, 30 ml) was added into the reaction vial, followed by extracting with ethyl acetate and water and collecting an organic layer. The solvent contained in the organic layer was removed using a rotary evaporator to obtain a crude product. The crude product was purified via column chromatography to obtain compound 3 described above as a colorless liquid.

The procedure of Example 1 was repeated except that compound 1 was replaced with compound 3 to obtain a compound represented by Formula (I-1b).

The compound of Formula (I-1b) was identified using an NMR spectrometer. The result is shown below.

¹H-NMR (CDCl₃, 400 MHz), δ (ppm): 0.96-1.00 (m, 6H), 1.40-1.49 (m, 2H), 1.58-1.74 (m, 4H), 2.38 (s, 3H), 2.62-2.67 (m, 4H), 7.21-7.55 (m, 10H).

### Example 3: Preparation of a Liquid Crystal Compound of Formula (I-1c)

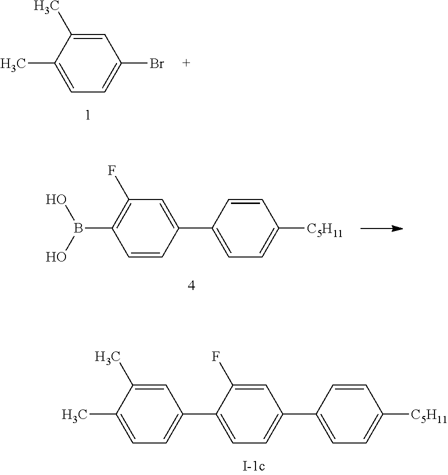

The procedure of Example 1 was repeated except that compound 2 was replaced with compound 4 to obtain a compound represented by Formula (I-1c).

The compound of Formula (I-1c) was identified using an NMR spectrometer. The result is shown below.

¹H-NMR (CDCl₃, 400 MHz), δ (ppm): 0.92 (m, 3H), 1.34-1.38 (m, 4H), 1.63-1.70 (m, 2H), 2.33 (d, J=6.8 Hz, 6H), 2.66 (t, J=7.6 Hz, 2H), 7.22-7.55 (m, 10H).

### Example 4: Preparation of a Liquid Crystal Compound of Formula (I-2a)

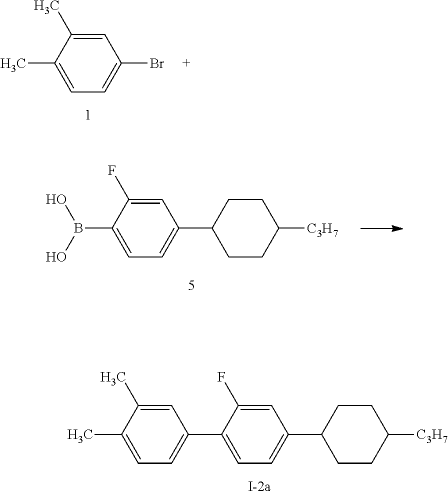

The procedure of Example 1 was repeated except that compound 2 was replaced with compound 5 to obtain a compound represented by Formula (I-2a).

The compound of Formula (I-2a) was identified using an NMR spectrometer. The result is shown below.

¹H-NMR (CDCl₃, 400 MHz), δ (ppm): 0.91 (t, J=7.2 Hz, 3H), 1.04-1.51 (m, 9H), 1.86-1.95 (m, 4H), 2.31 (d, J=4.8 Hz, 6H), 2.46-2.50 (m, 1H), 6.96-7.04 (m, 2H), 7.19 (d, J=8.0 Hz, 1H), 7.27-7.34 (m, 3H).

### Example 5: Preparation of a Liquid Crystal Compound of Formula (I-3a)

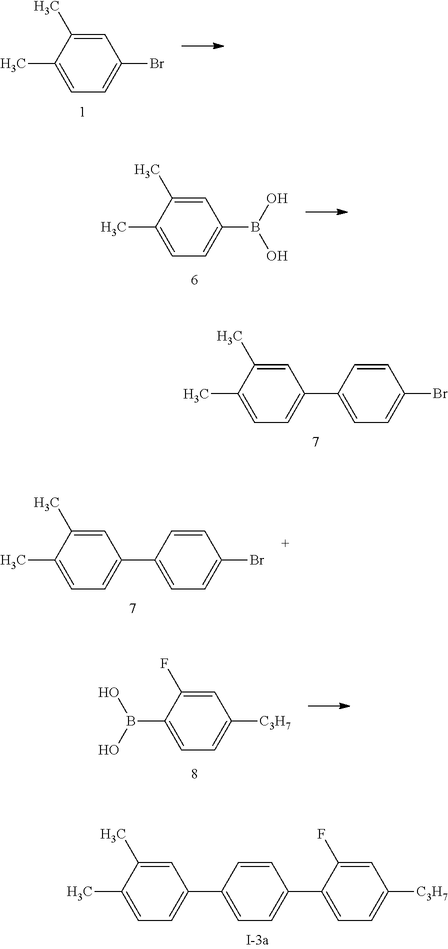

Compound 1 (10 g, 54.05 mmol) and anhydrous tetrahydrofuran (100 ml) were added into a reaction vial (250 ml) and were mixed under stirring until complete dissolution. The temperature in the reaction vial was reduced to −78° C., and n-butyl lithium (2.5M, 32.4 ml, 81.08 mmol) was added into the reaction vial slowly, followed by a reaction for 0.5 hour. Tri-isopropyl borate (20.3 g, 108.1 mmol) was added into the reaction vial at −78° C. to form a mixture, followed by subjecting the mixture in the reaction vial to a reaction at 0° C. for 1 hour. A dilute hydrochloric acid solution (1N, 80 ml) was added into the reaction vial, followed by stirring at a temperature from 20° C. to 30° C. for 0.5 hour and extracting with ethyl acetate and water and collecting an organic layer. The solvent contained in the organic layer was removed using a rotary evaporator to obtain a crude product. The crude product was purified via column chromatography to obtain compound 6 described above as a white solid.

1,4-dibromobenzene (3 g, 12.7 mmol), tetrahydrofuran (80 ml), water (15 ml), and potassium carbonate (7.9 g, 57.2 mmol) were added into a reaction vial (250 ml) and were mixed under stirring, followed by purging with nitrogen gas for 30 minutes to remove oxygen from the reaction vial. Compound 6 (1.9 g, 12.7 mmol) and tetrakis(triphenylphosphine) palladium (0) (0.37 g, 0.320 mmol) were added into the reaction vial to form a mixture. The mixture was heated under reflux for 5 hours, followed by extracting with ethyl acetate and water and collecting an organic layer. The solvent contained in the organic layer was removed using a rotary evaporator to obtain a crude product. The crude product was purified via column chromatography to obtain compound 7 as a white solid.

The procedure of Example 1 was repeated except that compound 1 was replaced with compound 7, and compound 2 was replaced with compound 8 to obtain a compound represented by Formula (I-3a).

The compound of Formula (I-3a) was identified using an NMR spectrometer. The result is shown below.

¹H-NMR (CDCl₃, 400 MHz), δ (ppm): 0.99 (t, J=7.2 Hz, 3H), 1.65-1.72 (m, 2H), 2.33 (d, J=11.6 Hz, 6H), 2.63 (t, J=7.6 Hz, 2H), 6.98-7.05 (m, 2H), 7.22 (d, J=7.6 Hz, 1H), 7.37-7.42 (m, 3H), 7.60-7.66 (m, 4H).

### Example 6: Preparation of a Liquid Crystal Compound of Formula (I-4a)

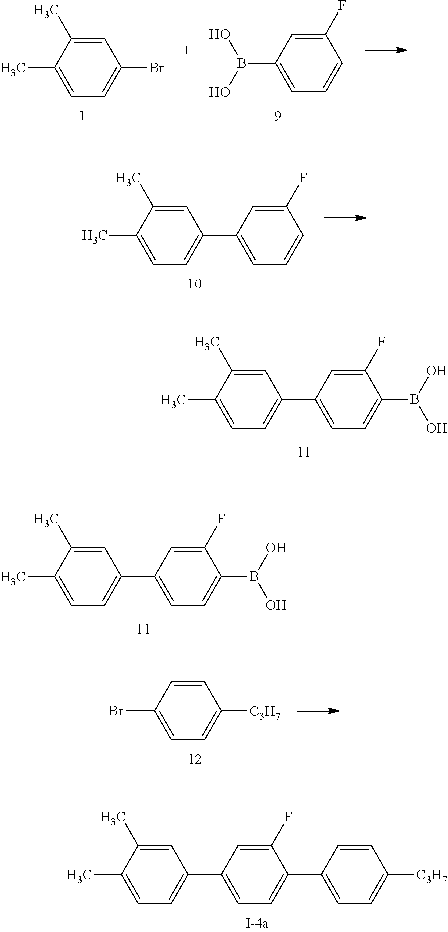

The procedure of Example 1 was repeated except that compound 2 was replaced with compound 9 to obtain compound 10 as a white solid.

Potassium tert-butoxide (2.02 g, 18.0 mmol) and anhydrous tetrahydrofuran (40 ml) were added into a reaction vial (250 ml) and were mixed under stirring until complete dissolution. The temperature in the reaction vial was reduced to −78° C., and n-butyl lithium (2.5M, 9.6 ml, 24.0 mmol) was added into the reaction vial slowly, followed by a reaction for 0.5 hour. A solution of compound 10, which was prepared by dissolving compound 10 (3.0 g, 15.0 mmol) into anhydrous tetrahydrofuran (10 ml), was added into the reaction vial at −78° C., followed by a reaction for 1 hour. Tri-isopropyl borate (5.6 g, 30 mmol) was added into the reaction vial at −78° C. to form a mixture, followed by subjecting the mixture in the reaction vial to a reaction at 0° C. for 1 hour. A dilute hydrochloric acid solution (1N, 30 ml) was added into the reaction vial, followed by stirring at a temperature from 20° C. to 30° C. for 0.5 hour and extracting with ethyl acetate and water and collecting an organic layer. The solvent contained in the organic layer was removed using a rotary evaporator to obtain a crude product. The crude product was purified via column chromatography to obtain compound 11 described above as a colorless liquid.

The procedure of Example 1 was repeated except that compound 1 was replaced with compound 12, and compound 2 was replaced with compound 11 to obtain a compound represented by Formula (I-4a) as a white solid.

The compound of Formula (I-4a) was identified using an NMR spectrometer. The result is shown below.

¹H-NMR (CDCl₃, 400 MHz), δ (ppm): 0.99 (t, J=7.6 Hz, 3H), 1.65-1.75 (m, 2H), 2.33 (d, J=11.2 Hz, 6H), 2.65 (t, J=7.6 Hz, 2H), 7.21-7.49 (m, 10H).

### Example 7: Preparation of a Liquid Crystal Compound of Formula (I-5a)

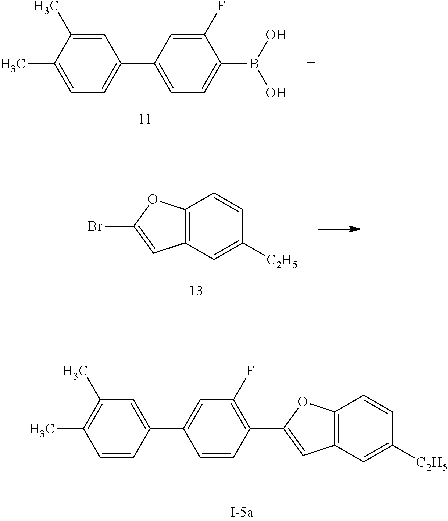 [SMILES: Cc1ccc(-c2ccc(B(O)O)c(F)c2)cc1C ; "+" ; CCc1ccc2oc(Br)cc2c1 ; CCc1ccc2oc(-c3ccc(-c4ccc(C)c(C)c4)cc3F)cc2c1]

The procedure of Example 1 was repeated except that compound 1 was replaced with compound 13, and compound 2 was replaced with compound 11 to obtain a compound represented by Formula (I-5a) as a white solid.

The compound of Formula (I-5a) was identified using an NMR spectrometer. The result is shown below.

¹H-NMR (CDCl₃, 400 MHz), δ (ppm): 1.31 (t, J=7.6 Hz, 3H), 2.34 (d, J=11.6 Hz, 6H), 2.76 (q, J=7.6 Hz, 2H), 7.14-7.24 (m, 3H), 7.36-7.49 (m, 6H), 8.05 (t, J=8.0 Hz, 1H).

### Example 8: Preparation of a Liquid Crystal Compound of Formula (I-6a)

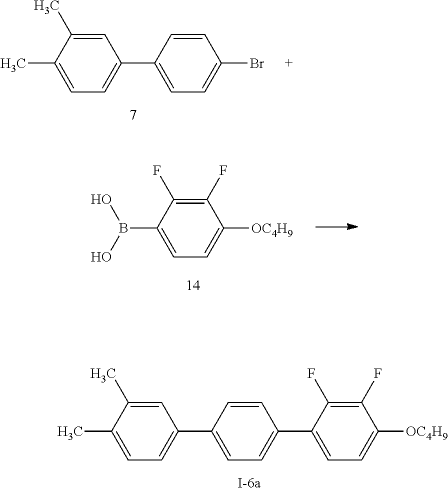

The procedure of Example 1 was repeated except that compound 1 was replaced with compound 7, and compound 2 was replaced with compound 14 to obtain a compound represented by Formula (I-6a) as a white solid.

The compound of Formula (I-6a) was identified using an NMR spectrometer. The result is shown below.

¹H-NMR (CDCl₃, 400 MHz), δ (ppm): 1.00 (t, J=7.2 Hz, 3H), 1.49-1.58 (m, 2H), 1.80-1.87 (m, 2H), 2.34 (d, J=11.2 Hz, 6H), 4.09 (t, J=6.4 Hz, 2H), 6.79-6.83 (m, 1H), 7.11-7.16 (m, 1H), 7.22 (d, J=8.0 Hz, 1H), 7.36-7.42 (m, 2H), 7.55-7.57 (m, 2H), 7.63-7.66 (m, 2H).

### Example 9: Preparation of a Liquid Crystal Compound of Formula (I-7a)

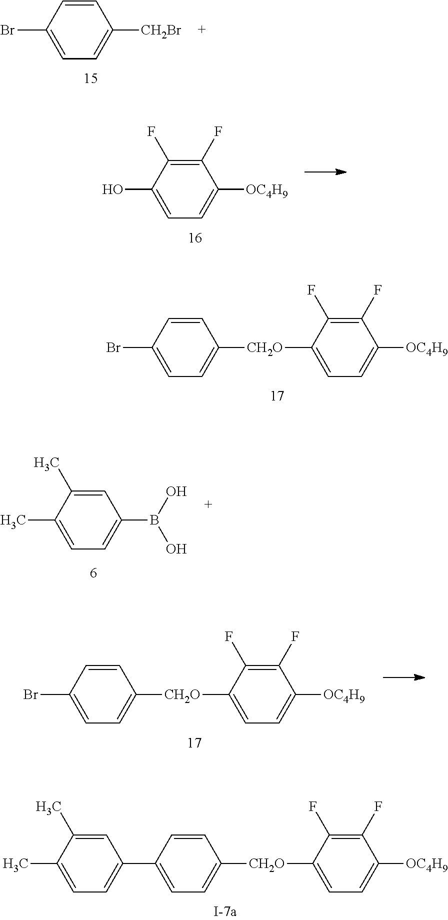

Sodium hydride (1.43 g, 59.6 mmol) N,N-dimethylformamide (40 ml) were added into a reaction vial (100 ml) and were mixed under stirring. The reaction vial was placed in an ice bath. Compound 16 (4.0 g, 19.8 mmol) was then added into the reaction vial, followed by a reaction in the ice bath for 0.5 hour. Compound 15 (7.4 g, 29.7 mmol) was then added into the reaction vial in the ice bath, followed by conducting a reaction at 100° C. for 5 hours, extracting with ethyl acetate and water, and collecting an organic layer. The solvent contained in the organic layer was removed using a rotary evaporator to obtain a crude product. The crude product was purified via column chromatography to obtain compound 17 described above as a white solid.

Compound 17 (1.7 g, 4.6 mmol), tetrahydrofuran (40 ml), water (8 ml), and potassium carbonate (3.5 g, 25.4 mmol) were added into a reaction vial (250 ml) and were mixed under stirring, followed by purging with nitrogen gas for 30 minutes to remove oxygen from the reaction vial. Compound 6 (1.4 g, 9.3 mmol) and tetrakis(triphenylphosphine) palladium (0) (0.30 g, 0.260 mmol) were added into the reaction vial to form a mixture. The mixture was heated under reflux for 5 hours, followed by extracting with ethyl acetate and water and collecting an organic layer. The solvent contained in the organic layer was removed using a rotary evaporator to obtain a crude product. The crude product was purified via column chromatography to obtain a compound of Formula (I-7a) as a white solid.

The compound of Formula (I-7a) was identified using a NMR spectrometer. The result is shown below.

¹H-NMR (CDCl₃, 400 MHz), δ (ppm): 0.97 (t, J=7.2 Hz, 3H), 1.44-1.54 (m, 2H), 1.73-1.80 (m, 2H), 2.32 (d, J=10.0 Hz, 6H), 3.98 (t, J=6.4 Hz, 2H), 5.11 (s, 2H), 6.58-6.62 (m, 1H), 6.65-6.70 (m, 1H), 7.20 (d, J=8.0 Hz, 1H), 7.32-7.37 (m, 2H), 7.46 (d, J=8.0 Hz, 2H), 7.59 (d, J=6.4 Hz, 2H).

### Example 10: Preparation of a Liquid Crystal Compound of Formula (I-8a)

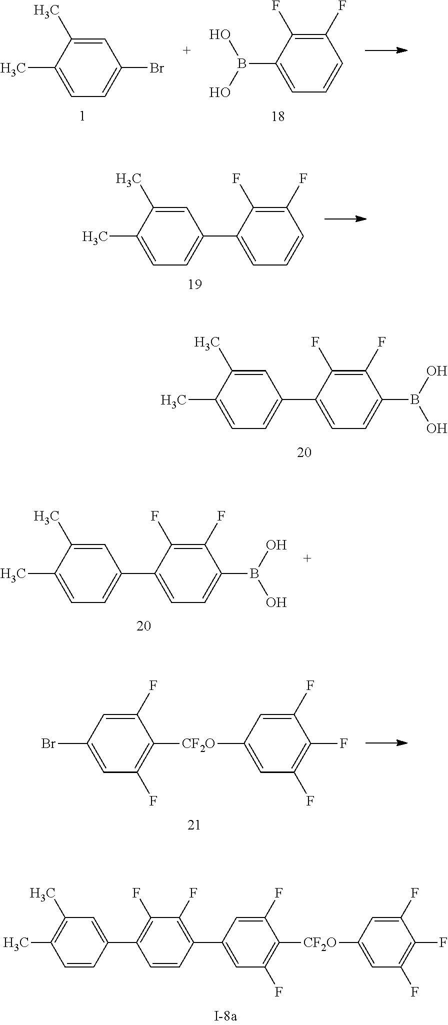

Compound 1 (4.1 g, 22.2 mmol), tetrahydrofuran (65 ml), water (16 ml), and potassium carbonate (13.8 g, 100.0 mmol) were added into a reaction vial (250 ml) and were mixed under stirring, followed by purging with nitrogen gas for 30 minutes to remove oxygen from the reaction vial. Compound 18 (7.0 g, 44.3 mmol) and tetrakis(triphenylphosphine) palladium (0) (1.0 g, 0.866 mmol) were added into the reaction vial to form a mixture. The mixture was heated under reflux for 5 hours, followed by extracting with ethyl acetate and water and collecting an organic layer. The solvent contained in the organic layer was removed using a rotary evaporator to obtain a crude product. The crude product was purified via column chromatography to obtain compound 19.

Potassium tert-butoxide (3.7 g, 33.4 mmol) and anhydrous tetrahydrofuran (100 ml) were added into a reaction vial (250 ml) and were mixed under stirring until complete dissolution. The temperature in the reaction vial was reduced to −78° C., and n-butyl lithium (2.5M, 14.3 ml, 35.8 mmol) was added into the reaction vial slowly, followed by a reaction for 0.5 hour. A solution of compound 19, which was prepared by dissolving compound 19 (5.2 g, 23.9 mmol) into anhydrous tetrahydrofuran (10 ml), was added into the reaction vial at −78° C., followed by a reaction for 1 hour. Tri-isopropyl borate (9.0 g, 47.7 mmol) was added into the reaction vial at −78° C. to form a mixture, followed by subjecting the mixture in the reaction vial to a reaction at 0° C. for 1 hour. A dilute hydrochloric acid solution (1N, 40 ml) was added into the reaction vial, followed by stirring at a temperature from 20° C. to 30° C. for 0.5 hour and extracting with ethyl acetate and water and collecting an organic layer. The solvent contained in the organic layer was removed using a rotary evaporator to obtain a crude product. The crude product was purified via column chromatography to obtain compound 20.

Compound 21 (3.96 g, 10.2 mmol), tetrahydrofuran (50 ml), water (10 ml), and potassium carbonate (6.3 g, 45.7 mmol) were added into a reaction vial (250 ml) and were mixed under stirring, followed by purging with nitrogen gas for 30 minutes to remove oxygen from the reaction vial. Compound 20 (4.0 g, 15.3 mmol) and tetrakis(triphenylphosphine) palladium (0) (0.30 g, 0.260 mmol) were added into the reaction vial to form a mixture. The mixture was heated under reflux for 5 hours, followed by extracting with ethyl acetate and water and collecting an organic layer. The solvent contained in the organic layer was removed using a rotary evaporator to obtain a crude product. The crude product was purified via column chromatography to obtain a compound represented by Formula (I-8a) as a white solid.

The compound of Formula (I-8a) was identified using an NMR spectrometer. The result is shown below.

¹H-NMR (CDCl₃, 400 MHz), δ (ppm): 2.34 (d, J=5.2 Hz, 6H), 6.97-7.02 (m, 2H), 7.21-7.36 (m, 7H).

### Example 11: Preparation of a Liquid Crystal Compound of Formula (I-8b)

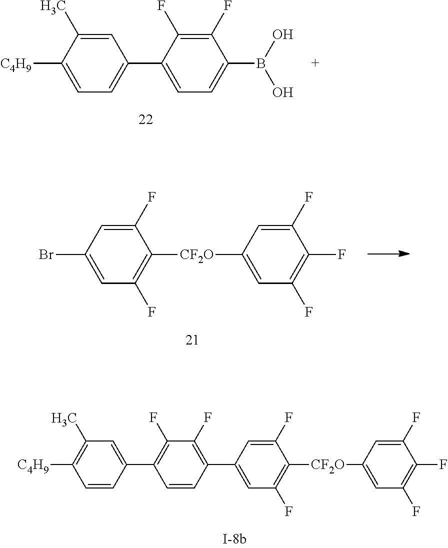

The procedure of Example 10 was repeated except that compound 20 was replaced with compound 22 to obtain a compound represented by Formula (I-8b) as a white solid.

The compound of Formula (I-8b) was identified using an NMR spectrometer. The result is shown below.

¹H-NMR (CDCl₃, 400 MHz), δ (ppm): 0.98 (t, J=7.2 Hz, 3H), 1.39-1.49 (m, 2H), 1.57-1.64 (m, 2H), 2.38 (s, 3H), 2.66 (t, J=7.6 Hz, 2H), 6.97-7.02 (m, 2H), 7.21-7.35 (m, 7H).

### Comparative Example 1: Preparation of a Liquid Crystal Compound CE1 of

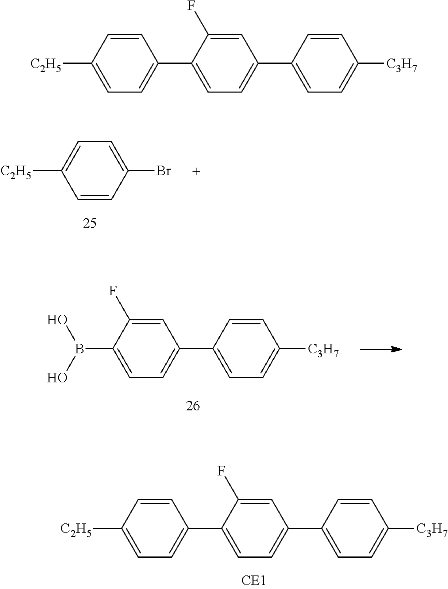

The procedure of Example 1 was repeated except that compound 1 was replaced with compound 25, and compound 2 was replaced with compound 26 to obtain compound CE1.

### Comparative Example 2: Preparation of a Liquid Crystal Compound CE2 of

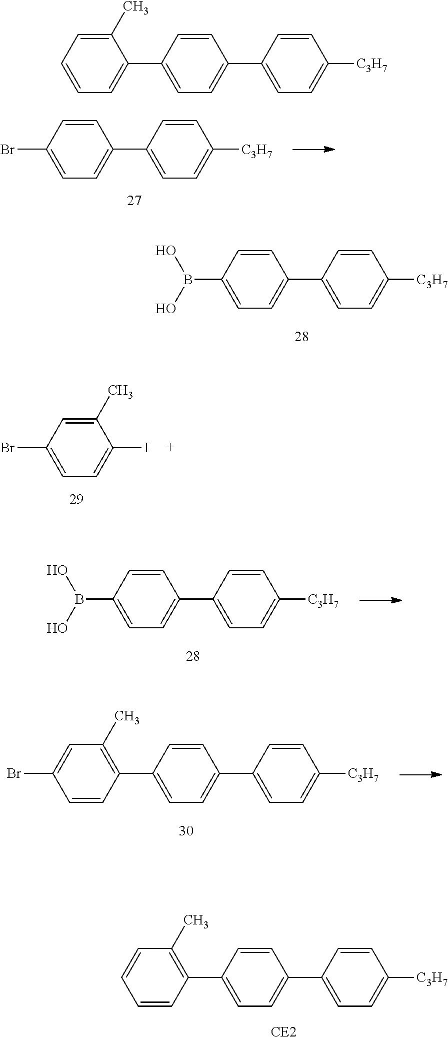

The procedure for preparing compound 6 in Example 5 was repeated except that compound 1 was replaced with compound 27 to obtain compound 28. The procedure of Example 1 was repeated except that compound 1 was replaced with compound 29, and compound 2 was replaced with compound 28 to obtain compound 30. Compound 30 was subjected to a hydrogenation reaction to obtain compound CE2.

The codes for representing the groups contained in the liquid crystal compounds described herein are shown in Table 1 below.

TABLE 1

| | | | | | |
|---|---|---|---|---|---|
| P | 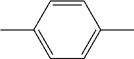 | C | 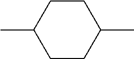 | UF | 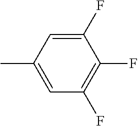 |
| G | 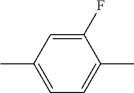 | U | 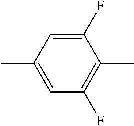 | RI | 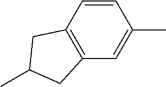 |
| G′ | 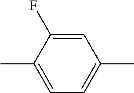 | Y | 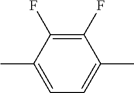 | B | 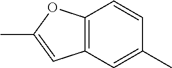 |
| M | 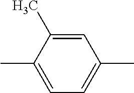 | Q V | —CF₂O— —CH═CH₂ | OCF3 T | —OCF₃ —C≡C— |
| V2 | CH₂═CH—CH₂—CH₂— | 2V | —CH₂—CH₂—CH═CH₂ | M′ | 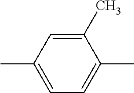 |
| V1 | CH₂═CH—CH₂— | 1~5 | alkyl (1~5 | OVF2 | —O—CH═CF₂ |
| | | | indicate the | | |
| | | | carbon number) | | |
| to | 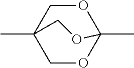 | do | 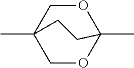 | | |

### Property Measurements:

The liquid crystal compounds obtained in the examples and the comparative examples described above and the liquid crystal composition obtained in the application examples and the comparative application examples described below were measured for various properties thereof by the methods described below.

### 1. Clearing Point (Tₙᵢ, ° C.):

A differential scanning calorimeter (DSC) system was used for measuring a clearing point (Tₙᵢ). An amount of 0.5-10 mg of a liquid crystal composition (or an analyte) was weighed on an aluminum plate. Phase transformation temperatures were determined from starting points of endothermic and exothermic peaks that appeared due to phase transformations of the liquid crystal composition (or the analyte). The phase transformations were indicated as follow: a crystalline phase: C, a smectic phase: S, a nematic phase: N, and an isotropic phase: I. The temperature at which the liquid crystal composition (or the analyte) transformed from the nematic phase to the liquid phase was recorded as a clearing point (Tₙᵢ) of the liquid crystal composition (or the analyte).

2. Rotational Viscosity (γ₁, mPa·s):

A liquid crystal composition (or an analyte) was placed in a liquid crystal cell. The liquid crystal cell was applied with a voltage of 20 V at a temperature of 25° C. A rotational viscosity (γ₁) was obtained via a calculation using an instrument with introduction of a dielectric anisotropy (Δε) factor.

### 3. K₁₁ Elastic Constant (“Splay”, pN Below 20° C.):

A liquid crystal composition (or an analyte) was placed in a liquid crystal cell. The liquid crystal cell was applied with a voltage of 20 V at a temperature of 25° C. K₁₁ elastic constant was obtained via a calculation using an instrument with introduction of a dielectric anisotropy (Δε) factor.

### 4. Refractive Index Anisotropy (Δn):

A liquid crystal composition (or an analyte) was measured using an Abbe refractometer (Manufacturer: ATAGO; Model: DR-M2) equipped with a polarizer attached to an eyepiece of the refractometer. A surface of a main prism of the Abbe refractometer was wiped in one direction. A small amount of the liquid crystal composition (or the analyte) was dripped on the main prism. The refractive index anisotropy was measured at 25° C. using a filter having a transmission wavelength of 589 nm. The refractive index measured in a polarization direction parallel to the wiping direction is designated as n∥, and the refractive index measured in a polarization direction transverse to the wiping direction is designated as n⊥. The refractive index anisotropy (Δn) was calculated according to a formula as below.

Δn=n∥−n⊥.

### 5. Low-Temperature Storage (LTS, Days):

0.3 g of a liquid crystal composition (or an analyte) was placed in a glass vial (7 ml). The glass vial with the liquid crystal composition (or the analyte) was disposed in a low-temperature freezer at −20°. The time period (in days) when liquid crystal precipitated from the liquid crystal composition was recorded. The longer the time period (in days) is, the better the low-temperature storage.

### Property Measurement of Liquid Crystal Compound:

The liquid crystal compounds and the amounts thereof shown in Table 2 below were used to form a mixture. The mixture was heated until a clear solution was formed. The clear solution was cooled to a room temperature to obtain a base liquid (referred to as base liquid (A)).

TABLE 2

| Compounds | Amounts (wt %) |
|---|---|
| 2RIGUQUF | 3.7 |
| 4 PGUQUF | 5 |
| 3CPTP2 | 3.3 |
| 3CCV | 53 |
| 3RIGUQUF | 3.7 |
| 3CCPOCF3 | 18.2 |
| 2PGB2 | 2.1 |
| 3PGUQUF | 5 |
| 3CCGF | 3 |
| 3PGB2 | 3 |

Each of the liquid crystal compounds of Examples 1 to 7 and Comparative Examples 1 and 2 was mixed with a portion of the base liquid (A) to form an analyte. The analyte was measured according to the measurement methods described above. The properties of the analyte where obtained via an extrapolation method based on the properties of the base liquid (A). The results are shown in Table 3.

TABLE 3

| | LTS | Tₙᵢ | | γ₁ | |
|---|---|---|---|---|---|
| | (day) | (° C.) | K₁₁ | (mPa · S) | Δn |
| Comp. Ex. 1 | 1 | 120 | 21.8 | 97 | 0.2636 |
| Comp. Ex. 2 | 0 | — | — | — | — |
| Ex. 1 | 6 | 62.5 | 20.4 | 118 | 0.2336 |
| Ex. 2 | 6 | 58 | 17.5 | 136 | 0.2169 |
| Ex. 3 | 8 | 62.5 | 19.0 | 132 | 0.2140 |
| Ex. 4 | 6 | 34 | 7.5 | 171 | 0.1297 |
| Ex. 5 | 4 | 63.5 | 20.4 | 133 | 0.2212 |
| Ex. 6 | 6 | 49 | 13.3 | 116 | 0.2165 |
| Ex. 7 | 4 | 130 | 27.6 | 163 | 0.3500 |

As shown in Table 3, the low-temperature storage for the liquid crystal compound of Comparative Example 1 is only 1 day. Contrarily, the low-temperature storage for each of the liquid crystal compounds of Examples 1 to 7 is at least 4 days, and even up to 8 days. It is demonstrated that the liquid crystal compound represented by Formula (I) according to the disclosure has superior low-temperature storage.

The molecular structure and the low-temperature storage of each of the liquid crystal compounds of Example 1 and Comparative Examples 1 and 2 are summarized in Table 4 below.

TABLE 4

| | | LTS |
|---|---|---|
| | Molecular Structures | (day) |
| Ex. 1 | 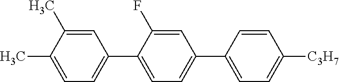 | 6 |
| Comp. Ex. 1 | 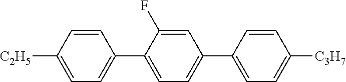 | 1 |
| Comp. Ex. 2 | 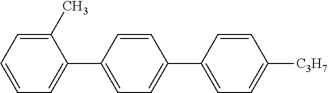 | 0 |

As shown in Table 4, by comparing Example 1 and Comparative Example 1, it is found that the low-temperature storage can be enhanced effectively via introduction of methyl in the molecular structure of the liquid crystal compound. Furthermore, by comparing Example 1 and Comparative Example 2, it is found that the low-temperature storage can be affected by the position of methyl introduced in the molecular structure of the liquid crystal compound. Specifically, when methyl is introduced at position 2 of a terminal phenyl group of the molecular structure of the liquid crystal compound, the low-temperature storage of the liquid crystal compound can be further enhanced.

### Application Examples 1 and 2 and Comparative Application Example 1: Preparation of Liquid Crystal Compositions

The liquid crystal compounds and the amounts thereof shown in Table 5 below were used to formulate another base liquid (referred to as base liquid (B)).

TABLE 5

| Compounds | Amounts (wt %) |
|---|---|
| 2RIGUQUF | 4.5 |
| 4 PGUQUF | 5 |
| 3CPTP2 | 2 |
| 3RIGUQUF | 3.5 |
| 3CCPOCF3 | 12.3 |
| 3CCV | 57 |
| 3PGUQUF | 5 |
| 5CCPOCF3 | 8.7 |
| V2PTP2V | 9 |

Each of the liquid crystal compositions of Application Examples 1 and 2 and Comparative Application Example 1 was prepared by mixing the components and the amounts thereof shown in Table 6, and was measured according to the measurement methods described above. The results are shown in Table 6.

TABLE 6

| | | Comp. Appl. | Appl. | Appl. |
|---|---|---|---|---|
| | | Ex. 1 | Ex. 1 | Ex. 2 |
| Components | 1MGB2 (Ex. 7) | —* | 3.4 | 3.4 |
| and | 3PGB2 | 3.4 | — | 3.4 |
| amounts | 2PGB2 | 3.4 | 3.4 | — |
| thereof | Base liquid (B) | 93.2 | 93.2 | 93.2 |
| (wt %) | | | | |
| Properties | LTS (day) | 0 | 5 | 5 |
| | Tₙᵢ (° C.) | 79.25 | 77.22 | 77.3 |
| | K₁₁ | 10.5 | 10.4 | 10.3 |
| | γ₁ | 42.52 | 42.47 | 43.43 |
| | (mPa · S) | | | |
| | Δn | 0.1073 | 0.1072 | 0.1073 |

*“—”: not added

As shown in Table 6, it is demonstrated that the liquid crystal composition prepared using the liquid crystal compound (i.e. 1MGB2) of the disclosure has superior low-temperature storage.

### Application Examples 3 to 5 and Comparative Application Examples 2 and 3: Preparation of Liquid Crystal Compositions

Each of the liquid crystal compositions of Application Examples 3 to 5 and Comparative Application Examples 2 and 3 was prepared by mixing the components and the amounts thereof shown in Table 7, and was measured according the measurement methods described above. The results are shown in Table 7.

TABLE 7

| Components and | | Appl. Ex. | | | Comp. Appl. Ex. | |
|---|---|---|---|---|---|---|
| Amounts thereof (wt %) | | 3 | 4 | 5 | 2 | 3 |
| Formula | 1MG′ P3 | 4.03 | 3.6 | 1.8 | —* | — |
| (I) | (Ex. 1) | | | | | |
| Formula | 3CCV | 57.57 | 58 | 59.5 | 58 | 52.9 |
| (II) | V2PTP2V | 10.48 | 10.5 | 10.5 | 10 | 12 |
| | 3CPTP2 | 2.02 | 1.8 | 5 | 2 | 5.6 |
| | 3PTPO1 | — | — | — | — | 1.7 |
| | 3PTPO2 | — | — | — | 3.7 | — |
| | 3PGB2 | 6.85 | 6.9 | 6.5 | 6 | 5.6 |
| | 2PGB2 | 6.85 | 6.9 | 6.5 | 8 | 5.5 |
| | 3CCGF | — | — | — | — | 1.9 |
| | 3CCPOCF3 | 2.02 | 1.8 | 1.5 | 4.14 | 7 |
| | 5CCPOCF3 | 2.02 | 1.8 | — | — | — |
| Formula | 3PGUQUF | 4.08 | 2.9 | 2.9 | 4.08 | 2.6 |
| (III) | 4PGUQUF | — | 2.9 | 2.9 | — | 2.6 |
| | 5PGUQUF | 4.08 | 2.9 | 2.9 | 4.08 | 2.6 |
| Proper- | LTS (day) | 14 | 7 | 16 | 0 | 0 |
| ties | Tₙᵢ (° C.) | 74.7 | 73.9 | 73.4 | 75.2 | 79.6 |
| | K₁₁ | 10.95 | 10.8 | 10.45 | 11 | 11.3 |
| | γ₁ (mPa · S) | 40.66 | 39.85 | 39.5 | 39.0 | 41.3 |
| | Δn | 0.1347 | 0.1351 | 0.1331 | 0.1370 | 0.1363 |

*“—”: not added

As shown in Table 7, it is demonstrated that the liquid crystal composition prepared using the liquid crystal compound (i.e. 1MG′P3) of the disclosure has superior low-temperature storage.

In view of the aforesaid, since the liquid crystal compound of the disclosure has a specific molecular structure represented by Formula (I), the liquid crystal composition including the liquid crystal compound of the disclosure has superior low-temperature stability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A liquid crystal compound represented by Formula (I): 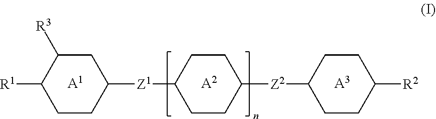
wherein
R¹ and R² each, independently of one another, represent a radical selected from the group consisting of F, Cl, H, a C₁-C₁₅ straight alkyl group, a C₃-C₁₅ branched alkyl group, a C₁-C₁₅ straight alkoxy group, and a C₃-C₁₅ branched alkoxy group, wherein at least one —CH₂— group in each of said C₁-C₁₅ straight alkyl group, said C₃-C₁₅ branched alkyl group, said C₁-C₁₅ straight alkoxy group, and said C₃-C₁₅ branched alkoxy group is optionally replaced with a radical selected from the group consisting of —C═C—, —CH═CH—, —CF₂O—, —O—, —COO—, —OCO—, and —OOC—, and each of said C₁-C₁₅ straight alkyl group, said C₃-C₁₅ branched alkyl group, said C₁-C₁₅ straight alkoxy group, and said C₃-C₁₅ branched alkoxy group is unsubstituted or substituted with at least one halogen atom;
R³ represents a radical selected from the group consisting of a C₁-C₃ straight alkyl group and a C₃-C₈ branched alkyl group;
ring A¹ represents a radical selected from the group consisting of 1,4-phenylene and 1,4-cyclohexylene;
ring A² and ring A each, independently of one another, represent a radical selected from the group consisting of 1,4-phenylene, 1,4-cyclohexylene, 2-fluoro-1,4-phenylene, 3-fluoro-1,4-phenylene, 2,6-difluoro-1,4-phenylene, 3,5-difluoro-1,4-phenylene, 2,3-difluoro-1,4-phenylene, 1,3-cyclopentylene, 1,3-cyclobutylene, pyridine-2,5-diyl, pyrimidine-2,5-diyl, benzofuran-2,5-diyl, 1,3-dioxane-2,5-diyl, and tetrahydropyran-2,5-diyl;
Z¹ and Z² are each, independently of one another, selected from the group consisting of a single bond, —CH₂—CH₂—, —C═C—, —CH═CH—, —CF₂O—, —OCF₂—, —CH₂O—, —OCH₂—, —COO—, —OCO—, —OOC—, —CF₂—CF₂—, and —CF═CF—; and
n is an integer from 0 to 4,
with the proviso that
at least one of said ring A² and said ring A³ is a radical selected from the group consisting of 2-fluoro-1,4-phenylene, 3-fluoro-1,4-phenylene, 2,6-difluoro-1,4-phenylene, 3,5-difluoro-1,4-phenylene, and 2,3-difluoro-1,4-phenylene;
when n is 0, said ring A³ is not 2,3-difluoro-1,4-phenylene;
when n is an integer from 2 to 4, said rings A² are the same or different; and
when Z² represents —CF₂O— and said ring A³ represents 2,6-difluoro-1,4-phenylene, n is 2 and

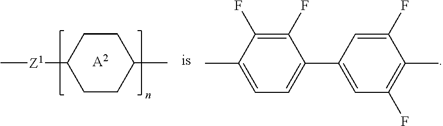

2. The liquid crystal compound according to claim 1, wherein R³ is methyl.

3. The liquid crystal compound according to claim 1, wherein Z¹ is a single bond.

4. The liquid crystal compound according to claim 3, wherein Z² is selected from the group consisting of a single bond, —CH₂O— and —CF₂O—.

5. The liquid crystal compound according to claim 1, wherein said liquid crystal compound represented by Formula (I) is selected from the group consisting of liquid crystal compounds represented by Formulae (I-1), (I-2), (I-3), (I-4), (I-5), (I-6), (I-7), and (I-8),

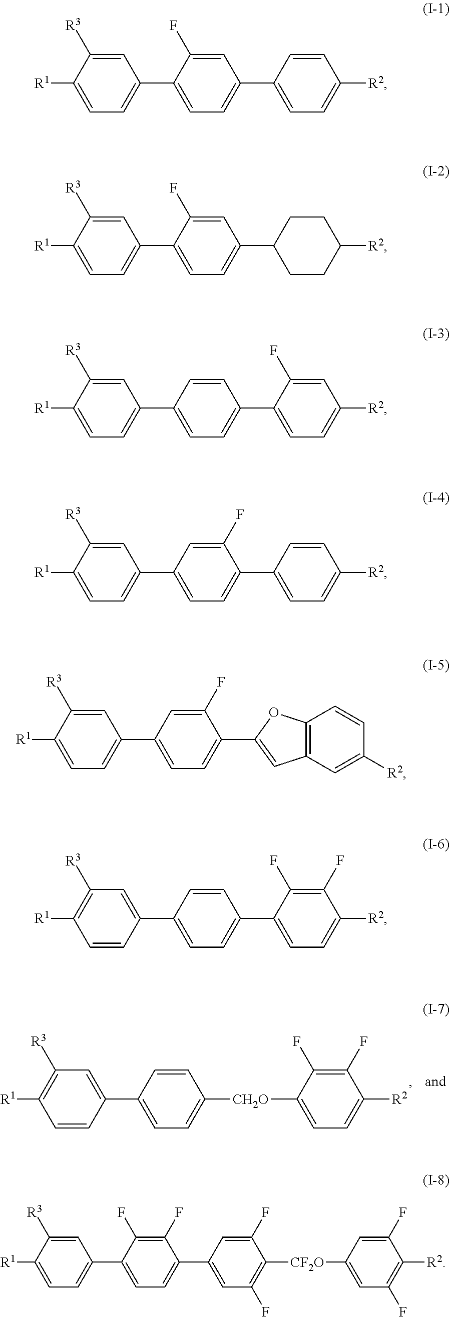

6. The liquid crystal compound according to claim 5, wherein R³ is methyl.

7. The liquid crystal compound according to claim 5, wherein R¹ is a radical selected from the group consisting of a C₁-C₅ straight alkyl group and a C₃-C₅ branched alkyl group, and R² is a radical selected from the group consisting of F, a C₁-C₅ straight alkyl group, a C₃-C₅ branched alkyl group, a C₁-C₅ straight alkoxy group, and a C₃-C₅ branched alkoxy group.

8. A liquid crystal composition, comprising the liquid crystal compound according to claim 1.

9. The liquid crystal composition according to claim 8, further comprising a liquid crystal compound represented by Formula (II), 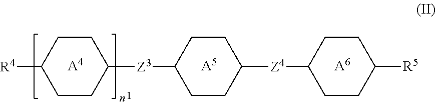
wherein
R⁴ and R⁵ each, independently of one another, represent a radical selected from the group consisting of H, a halogen atom, a C₁-C₁₅ straight alkyl group, a C₃-C₁₅ branched alkyl group, a C₂-C₁₅ straight alkenyl group, and a C₄-C₁₅ branched alkenyl group, wherein each of said C₁-C₁₅ straight alkyl group, said C₃-C₁₅ branched alkyl group, said C₂-C₁₅ straight alkenyl group, and said C₄-C₁₅ branched alkenyl group is independently unsubstituted or substituted with at least one halogen atom, and at least one —CH₂— group in each of said C₁-C₁₅ straight alkyl group, said C₃-C₁₅ branched alkyl group, said C₂-C₁₅ straight alkenyl group, and said C₄-C₁₅ branched alkenyl group is optionally replaced with a —O— radical, with the proviso that when at least two of said —CH₂— groups are replaced with said —O— radicals, said —O— radicals are not bonded to each other directly;
ring A⁴, ring A⁵, and ring A⁶ each, independently of another, represent a radical selected from the group consisting of 1,4-phenylene, 1,4-cyclohexylene, benzofuran-2,5-diyl, 1,3-dioxane-2,5-diyl, tetrahydropyran-2,5-diyl, a divalent dioxa-bicyclo[2.2.2]octyl functional group, a divalent trioxa-bicyclo[2.2.2]octyl functional group, and indane-2,5-diyl, wherein each of said 1,4-phenylene, said benzofuran-2,5-diyl, said 1,3-dioxane-2,5-diyl, said tetrahydropyran-2,5-diyl, said divalent dioxa-bicyclo[2.2.2]octyl functional group, and said divalent trioxa-bicyclo[2.2.2]octyl functional group is unsubstituted or substituted with at least one fluorine, said indane-2,5-diyl is unsubstituted or substituted with at least one radical selected from the group consisting of a halogen atom and CN, and at least one —CH₂— group in each of said 1,4-cyclohexylene, said 1,3-dioxane-2,5-diyl, said tetrahydropyran-2,5-diyl, said divalent dioxa-bicyclo[2.2.2]octyl functional group, said divalent trioxa-bicyclo[2.2.2]octyl functional group, and said indane-2,5-diyl is replaced with a first radical selected from the group consisting of —O—, —N—, and —S—, with the proviso that when at least two of said —CH₂— groups are replaced with said first radicals, said first radicals are not bonded to each other directly;
Z³ and Z⁴ are each, independently of one another, selected from the group consisting of a single bond, a C₁-C₄ alkylene group, a C₂-C₄ alkenylene group, and a C₂-C₄ alkynylene group, wherein each of said C₁-C₄ alkylene group, said C₂-C₄ alkenylene group, and said C₂-C₄ alkynylene group is unsubstituted or substituted with at least one CN, and at least one —CH₂— group in each of said C₁-C₄ alkylene group, said C₂-C₄ alkenylene group, and said C₂-C₄ alkynylene group is replaced with a radical selected from the group consisting of —O— and —S—, with the proviso that —O— and —S— are not bonded to each other directly, —O— is not bonded to —O— directly, and —S— is not bonded to —S— directly; and
n¹ is an integer from 0 to 2.

10. The liquid crystal composition according to claim 8, further comprising a liquid crystal compound represented by Formula (III), 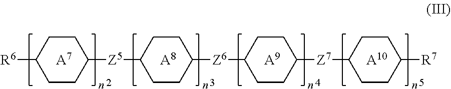
wherein
R⁷ represents a radical selected from the group consisting of F, Cl, —CH₃, —CF₃, —OCH═CF₂, and —OCF₃;
R⁶ represents a radical selected from the group consisting of H, a C₁-C₁₀ straight alkyl group, a C₃-C₁₀ branched alkyl group, a C₂-C₁₀ straight alkenyl group, and a C₄-C₁₀ branched alkenyl group, wherein each of said C₁-C₁₀ straight alkyl group, said C₃-C₁₀ branched alkyl group, said C₂-C₁₀ straight alkenyl group, and said C₄-C₁₀ branched alkenyl group is unsubstituted or substituted with at least one radical selected from the group consisting of a halogen atom, CN, and CF₃, and at least one —CH₂— group in each of said C₁-C₁₀ straight alkyl group, said C₃-C₁₀ branched alkyl group, said C₂-C₁₀ straight alkenyl group, and said C₄-C₁₀ branched alkenyl group is replaced with a second radical selected from the group consisting of —O—, —S—, —CO—, —O—CO—, —CO—O—, and —O—CO—O—, with the proviso that when at least two of said —CH₂— groups are replaced with said second radicals, said second radicals are not bonded to each other directly;
ring A⁷, ring A⁸, ring A⁹, and ring A¹⁰ each, independently of one another, represent a radical selected from the group consisting of 1,4-phenylene, 1,4-cyclohexylene, tetrahydropyran-2,5-diyl, a divalent dioxa-bicyclo[2.2.2]octyl functional group, a divalent trioxa-bicyclo[2.2.2]octyl functional group, and indane-2,5-diyl, wherein each of said 1,4-phenylene, said 1,4-cyclohexylene, and said indane-2,5-diyl is unsubstituted or substituted with at least one radical selected from the group consisting of a halogen atom and CN, and at least one —CH₂— group in each of said 1, 4-phenylene, said 1,4-cyclohexylene, and said indane-2,5-diyl is replaced with a third radical selected from the group consisting of —O—, —N—, and —S—, with the proviso that when at least two of said —CH₂— groups are replaced with said third radicals, said third radicals are not bonded to each other directly;
Z⁵, Z⁶, and Z⁷ are each, independently of one another, selected from the group consisting of a single bond, a C₁-C₄ alkylene group, a C₂-C₄ alkenylene group, a C₂-C₄ alkynylene group, —CO—O—, and —O—CO—, wherein each of said C₁-C₄ alkylene group, said C₂-C₄ alkenylene group, and said C₂-C₄ alkynylene group is unsubstituted or substituted with at least one halogen atom, and at least one —CH₂— group in each of said C₁-C₄ alkylene group, said C₂-C₄ alkenylene group, and said C₂-C₄ alkynylene group is replaced with a radical selected from the group consisting of —O— and —S—, with the proviso that —O— and —S— are not bonded to each other directly, —O— is not bonded to —O— directly, and —S— is not bonded to —S— directly, and that at least one of Z⁵, Z⁶, and Z⁷ is selected from the group consisting of —CF₂—O— and —O—CF₂—; and
n², n³, n⁴, and n⁵ each, independently of one another, represent an integer from 0 to 3, with the proviso that a total of n², n³, n⁴, and n⁵ is at least 3.
